(19) United States
(12) Patent Application Publication
(10) Pub. No.: US 2026/0192269 A1
(43) Pub. Date: Jul. 9, 2026

(54) METHODS FOR OPERATING A MIXING APPLIANCE

(71) Applicant: Haier US Appliance Solutions, Inc., Wilmington, DE (US)

(72) Inventors: Alexander Miller, Louisville, KY (US); Tomas Garces, Louisville (KY)

(21) Appl. No.: 19/014,300

(22) Filed: Jan. 9, 2025

(51) Int. Cl. B01F 35/222; A21C 11/10; A21C 11/16; A47J 43/044; A47J 43/07; A47J 43/08; B01F 35/212; B01F 35/221; B01F 35/32; B01F 35/33; B01F 101/00

(52) U.S. Cl. CPC B01F 35/222; A21C 11/10; A21C 11/16; A47J 43/044; A47J 43/0711; A47J 43/082; B01F 35/212; B01F 35/221422; B01F 35/3204; B01F 35/3214; B01F 35/332; A47J 2043/04454; B01F 2101/1805

(57) ABSTRACT

A method for operating a mixing appliance includes receiving data indicative of a first operational parameter associated with the drive assembly rotation of the mixing appliance. Additionally, the method includes determining the first operational parameter based on the received data. Furthermore, the method includes operating the motor to adjust a second operational parameter associated with the drive assembly rotation based on the determined first operational parameter. The first operational parameter is different from the second operational parameter.

### FIELD OF THE INVENTION

The present disclosure relates generally to mixing appliances, such as stand mixers, or more specifically, to methods for operating a mixing appliance.

### BACKGROUND OF THE INVENTION

Stand mixers are generally used for performing automated mixing, churning, or kneading involved in food preparation. Typically, stand mixers include a motor configured to provide torque to one or more drive shafts. Users may connect various utensils to the one or more drive shafts, including whisks, spatulas, or the like. Oftentimes various operational parameters associated with rotation of the motor/drive shaft, such as rotational speed, rotational direction, and/or the like, need to be adjusted. However, adjusting the operational parameters often requires manual adjustment or manual input by the stand mixer user.

Accordingly, methods for operating a mixing appliance would be desirable. More specifically, methods for operating the mixing appliance to automatically adjust various operational parameters associated with the motor/drive shaft would be particularly beneficial.

### BRIEF DESCRIPTION OF THE INVENTION

Aspects and advantages of the invention will be set forth in part in the following description, or may be apparent from the description, or may be learned through practice of the invention.

In one example aspect, a method for operating a stand mixer is provided. The stand mixer includes a drive assembly. The drive assembly includes a motor and a drive shaft. The motor is configured to rotate the drive shaft to drive a component of the stand mixer. The method includes receiving, with a controller, data indicative of a torque of the motor. Additionally, the method includes determining, with the controller, the torque of the motor based on the received data. Furthermore, the method includes operating, with the controller, the motor to adjust an operational parameter associated with drive assembly rotation based on the determined torque of the motor. The operational parameter is different from the torque of the motor.

In another example aspect, a method for operating a mixing appliance is provided. The mixing appliance includes a drive assembly. The drive assembly includes a motor and a drive shaft. The motor is configured to rotate the drive shaft to drive a component of the mixing appliance. The method includes receiving, with a controller, data indicative of a first operational parameter associated with drive assembly rotation. Additionally, the method includes determining, with the controller, the first operational parameter based on the received data. Furthermore, the method includes operating, with the controller, the motor to adjust a second operational parameter associated with the drive assembly rotation based on the determined first operational parameter. The first operational parameter is different from the second operational parameter.

In another example aspect, a stand mixer is provided. The stand mixer includes a base. Additionally, the stand mixer includes a support column. The support column is coupled to the base. Furthermore, the support column extends upwardly from the base. Moreover, the stand mixer includes a head. The head is coupled to an upper end of the support column. Additionally, the head extends from the support column above the base. Furthermore, the stand mixer includes an attachment. The attachment is coupled to the head. Moreover, the attachment is configured to manipulate food content. Additionally, the stand mixer includes a drive assembly. The drive assembly includes a motor. Furthermore, the drive assembly includes a drive shaft. The motor is configured to rotate the driveshaft to drive a component of the attachment. Moreover, the stand mixer includes a sensor. The sensor is configured to generate data indicative of a first operational parameter associated with drive assembly rotation. Additionally, the stand mixer includes a controller. The controller is operatively coupled to the sensor and the motor. The controller is configured to operate the motor to adjust a second operational parameter associated with drive assembly rotation based on the indicated first operational parameter. The first operational parameter is a different type of parameter than the second operational parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example embodiment of a stand mixer of the present disclosure.

FIG. 2 provides a perspective view of the example stand mixer of FIG. 1 with an example embodiment of an attachment coupled to the stand mixer.

FIG. 3 provides a flowchart of an example method for operating a mixing appliance according to example embodiments of the present disclosure.

FIG. 4 provides a flowchart of another example method for operating a mixing appliance according to example embodiments of the present disclosure.

FIG. 5 provides a diagrammatic view of torque of a motor of a mixing appliance plotted as a function of time.

### DETAILED DESCRIPTION OF THE INVENTION

Reference now will be made in detail to embodiments of the invention, one or more examples of which are illustrated in the drawings. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations may be made in the present invention without departing from the scope of the invention. For instance, features illustrated or described as part of one embodiment may be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

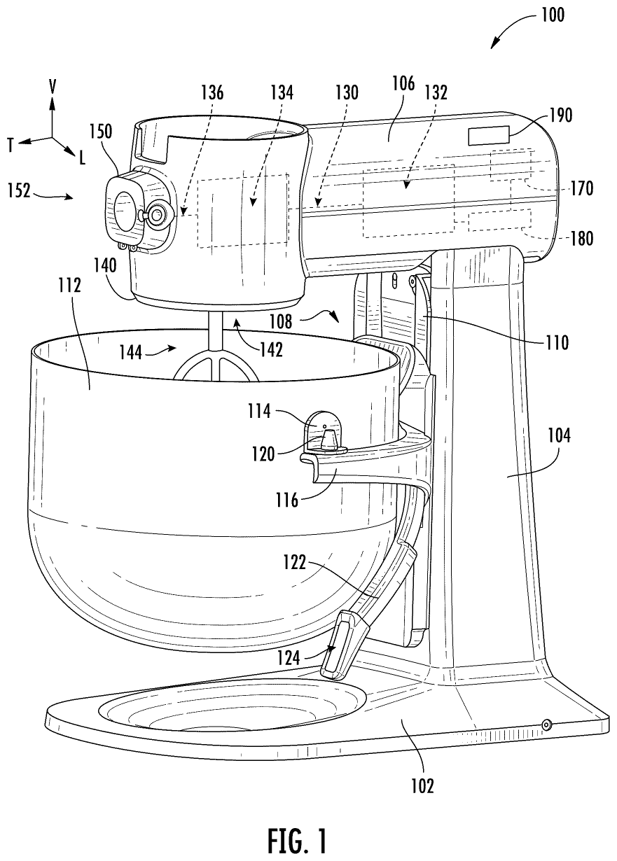

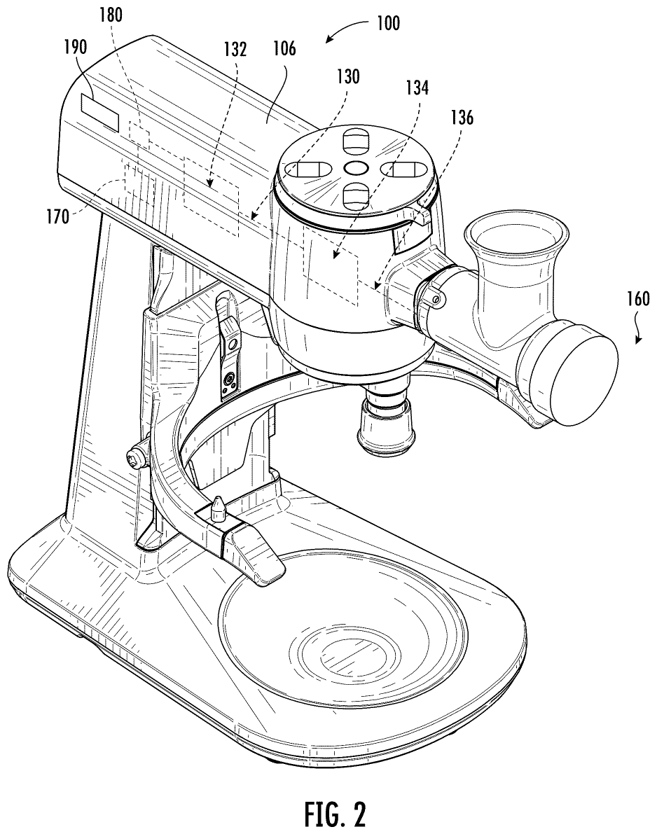

Referring to the figures, FIGS. 1 and 2 provide perspective views of a mixing appliance according to an example embodiment of the present subject matter. As shown in FIGS. 1 and 2 and as described herein, the mixing appliance is configured as a stand mixer 100. However, it will be appreciated that stand mixer 100 is provided by way of example only and that the present subject matter may be used in or with any suitable mixing appliance, such as a hand mixer, an immersion blender, a countertop blender, and/or the like, in alternative example embodiments. Moreover, with reference to each of FIGS. 1 and 2, stand mixer 100 may define a vertical direction V, a lateral direction L, and a transverse direction T, which are mutually perpendicular and form an orthogonal direction system. It should be understood that these directions are presented for example purposes only, and that relative positions and locations of certain aspects of stand mixer 100 may vary according to specific embodiments, spatial placement, or the like.

As shown, stand mixer 100 includes a base 102 and may include a support post or column 104. The column 104 may include a bowl support 108. The bowl support 108 may slidably mount to a column rail 110, which is mounted to column 104. Additionally, components of bowl support 108 may extend outwardly above base 102, e.g., in the transverse direction T, and may hold bowl 112 above base 102, e.g., along the vertical direction V. The bowl 112 may be removably mounted on bowl support 108 via flanges 114. The flanges 114 may be on opposite sides of the bowl 112 with respect to the circumference of the bowl.

Additionally, as best illustrated in FIG. 1, bowl support 108 may include an arm 116 with a mounting spike 120. The arm 116 may hold bowl 112 via mounting spike 120, which may removably couple to flanges 114. For instance, each mounting spike 120 on arm 116 may be received within a respective flange 114 on bowl 112. One or more lift levers 122, such as two lift levers 122, may rotatably couple to arm 116. Thus, bowl 112 may be disposed between lift levers 122, e.g., along the lateral direction L. Each lift lever 122 may be positioned on a respective side of bowl 112, such that both a left-handed user and a right-handed user may comfortably operate lift levers 122. Each of the lift levers 122 may have one end, a distal end 124, cantilevered from support column 104. The distal end 124 may correspond to a handle for a user to grasp, push, or pull.

Furthermore, support column 104 may support a mixer head 106, which is positioned atop column 104. For example, as shown in FIG. 1, head 106 may be mounted to column 104, which is mounted to base 102. Thus, column 104 may extend between and connect base 102 and head 106, e.g., along the vertical direction V. The head 106 may extend outwardly above the base 102, e.g., in the transverse direction T. Furthermore, mixer head 106 may house a drive assembly 130 of stand mixer 100. The drive assembly 130 may include a motor 132, a gearbox 134, and/or a drive shaft 136. The motor 132 may be configured to rotate drive shaft 136 bi-directionally, or in a first rotational direction (e.g., clockwise rotation) and a second rotational direction (e.g., counterclockwise rotation) different from the first rotational direction. The structure and operation of drive components, e.g., motor, gearbox, and drive shaft, are understood by those of ordinary skill in the art. As such, these components are illustrated diagrammatically and are not discussed in comprehensive details herein for the sake of brevity and clarity.

Furthermore, head 106 may include a mixing attachment support 140. The mixing attachment support 140 may be located on a lower portion or underside 142 of head 106 and forward of support column 104 along transverse direction T. A rotating mixing attachment 144 may be removably coupled to the mixing attachment support 140. Additionally, drive shaft 136 may connect motor 132 with gearbox 134 and mixing attachment support 140 such that motor 132 may drive rotation of mixing attachment 144 when mixing attachment 144 is coupled to mixing attachment support 140. Furthermore, gearbox 134 may allow user selection of different rotating speeds for mixing attachment 144. The stand mixer 100 may include one or more controls for operations such as selectively powering motor 132, choosing the speed of rotation for mixing attachment 144, choosing the direction of rotation for mixing attachment 144, and/or other features. In certain embodiments, mixing attachment support 140 may accept more than one type of mixing attachment 144. Various types of mixing attachments may be used including e.g., whisks, paddles, dough hooks, beaters, and others for purposes of mixing ingredients within a bowl or other container supported by the base 102. During use, mixing attachment 144 may be rotated in a circular or planetary manner. Rotation in a planetary manner, as used herein, includes rotating both in a circular manner and rotating about an axis that moves in a circular manner.

An example operation of an exemplary embodiment of stand mixer 100 of the present disclosure is described below. In the operation of stand mixer 100, a user may load food items into bowl 112. The food items may be ingredients, such as flour, water, milk, etc. These items are provided for example purposes only and one skilled in the art would appreciate that there are many more types of food items that may be placed in bowl 112 of stand mixer 100. After loading the food items into bowl 112, a user may turn on stand mixer 100 to begin the process of mixing, kneading, beating, etc. The motor 132 rotates an attachment, such as mixing attachment 144, attached to stand mixer 100 to complete each of these processes.

Moreover, head 106 includes an auxiliary attachment support 150 located on a forward portion or frontside 152 of head 106 in the transverse direction T and forward of support column 104 in the transverse direction T. An auxiliary attachment (FIG. 2), such as a pasta extruder attachment 160, may be removably coupled to auxiliary attachment support 150. For example, a removable pin (not shown) may couple pasta extruder attachment 160 to auxiliary attachment support 150. The drive shaft 136 may connect motor 132 with gearbox 134 and auxiliary attachment support 150 such that motor 132 may drive rotation of various components of the pasta extruder attachment 160 when pasta extruder attachment 160 is coupled to auxiliary attachment support 150. In certain embodiments, auxiliary attachment support 150 may accept more than one type of auxiliary attachment. For example, various types of auxiliary attachments may be used for the purpose of molding or forming dough into molded shapes or otherwise processing food.

Moreover, the mixing attachment 144 and/or the auxiliary attachment may include a rotatable tool for manipulating food content. For example, in some embodiments, pasta extruder attachment 160 may include a rotatable cutting tool or blade (not shown). The rotatable cutting tool may be operably coupled to drive assembly 130, such as to drive shaft 134. As such, rotation of drive shaft 134 by motor 132 results in rotation of the rotatable cutting tool. The rotatable cutting tool may be positioned “downstream” of a pasta extruder or outlet mold (not shown) of pasta extruder attachment 160. In this respect, as pasta is formed or extruded by the outlet mold, motor 132 drives rotation of the rotatable cutting tool so that the rotatable cutting tool cuts extruded/formed pasta into separate pasta pieces.

Additionally, the mixing attachment 144 and/or the auxiliary attachment may include a brake (not shown) configured to prevent or inhibit rotation of the rotatable tool, e.g., the rotatable cutting tool. For example, the brake may be configured as an arm or bumper that the rotatable cutting tool physically contacts during rotation of the rotatable cutting tool. Upon contact with the bumper, the rotatable cutting tool may be inhibited or prevented from continued rotation in the direction of which the rotatable cutting tool is rotating. Inhibiting or preventing rotation of the rotatable cutting tool may increase a torque of/applied to motor 132. As will be described below, increases in the torque applied to motor 132 may be utilized to adjust one or more operational parameters, such as rotational direction, associated with drive assembly 130.

Furthermore, in some embodiments, one or more sensors 170 may be provided in operative association with stand mixer 100. The sensor(s) 170 is configured to measure or generate data indicative of a first operational parameter associated with rotation of drive assembly 130. In some embodiments, sensor(s) 170 may be configured to generate data of a current of motor 132, which may be indicative of torque of motor 132, such as the torque applied to motor 132. For example, sensor(s) 170 may be configured as a current transformer (CT) sensing device. Additionally, or alternatively, in some embodiments, sensor(s) 170 may be configured to generate data indicative of a rotational speed of motor 132 and/or drive shaft 134 of drive assembly 130. For example, sensor(s) 170 may be configured as an optical sensor and/or the like. Additionally, or alternatively, in some embodiments, sensor(s) 170 may be configured to generate data indicative of a rotational direction, e.g., clockwise direction and/or counterclockwise direction, of motor 132 and/or drive shaft 134 of drive assembly 130. For example, sensor(s) 170 may be configured as an optical sensor and/or the like. As will be described below, a controller may utilize the data generated by the sensor(s) 170 to adjust one or more second operational parameters associated with rotation of drive assembly 130.

The stand mixer 100 may further include a controller 180. Operation of stand mixer 100 is regulated by controller 180 that is operatively coupled to a control panel 190. In some exemplary embodiments, control panel 190 may represent a general purpose I/O (“GPIO”) device or functional block. In some exemplary embodiments, control panel 190 may include input components, such as one or more of a variety of electrical, mechanical or electro-mechanical input devices including rotary dials, push buttons, touch pads, and touch screens. The control panel 190 may be communicatively coupled with controller 180 via one or more signal lines or shared communication busses. The control panel 190 provides selections for user manipulation of the operation of stand mixer 100, e.g., whereby a user may provide one or more rotational speeds at which drive assembly 130 of stand mixer 100 may operate. In response to user manipulation of the control panel 190, controller 180 operates various components of stand mixer 100. For example, controller 180 is operatively coupled or in communication with motor 132. The controller 180 may also be operatively coupled or in communication with one or more sensors such as, for example, sensor(s) 170. The controller 180 may receive signals or data from these sensor(s) 170 that are indicative of the first operational parameter(s) associated with rotation of drive assembly 130 as described above. Furthermore, control panel 190 may be configured to provide feedback from controller 180 to the user of stand mixer 100. As such, control panel 190 may include one or more feedback devices (not shown), which are configured to provide feedback from the controller 180 to the user.

The controller 180 includes memory and one or more processing devices such as microprocessors, CPUs or the like, such as general or special purpose microprocessors operable to execute programming instructions or micro-control code associated with operation of stand mixer 100. The memory may represent random access memory such as DRAM, or read only memory such as ROM or FLASH. The processor executes programming instructions stored in the memory. The memory may be a separate component from the processor or may be included onboard within the processor. Alternatively, controller 180 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. The controller 180 may be positioned in a variety of locations throughout stand mixer 100.

The controller 180 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices may store information and/or data accessible by the one or more processors, including instructions that may be executed by the one or more processors. It should be appreciated that the instructions may be software written in any suitable programming language or may be implemented in hardware. Additionally, or alternatively, the instructions may be executed logically and/or virtually using separate threads on one or more processors.

For example, controller 180 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 180 as disclosed herein is capable of and may be operable to perform any methods, method steps, or portions of methods as disclosed herein. For example, in some embodiments, methods disclosed herein may be embodied in programming instructions stored in the memory and executed by controller 180.

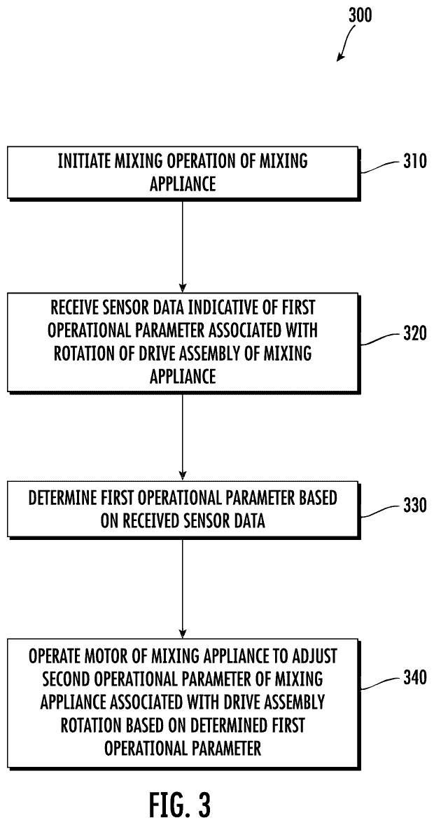

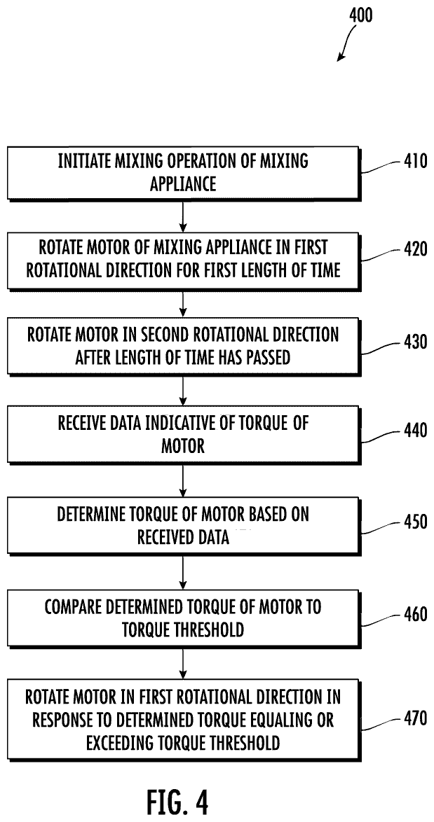

Referring now generally to FIGS. 3 and 4, the methods 300 and/or 400 may be interrelated and/or may have one or more steps from one of the methods 300 and 400 combined with the other method 300 or 400. Thus, those of ordinary skill in the art will recognize that the various steps of the exemplary methods described herein may be combined in various ways to arrive at additional embodiments within the scope of the present disclosure.

FIGS. 3 and 4 depict steps in a particular order for purposes of illustration and discussion. Those of ordinary skill in the art, using the disclosures provided herein, will understand that (except as otherwise indicated) methods 300 and 400 are not mutually exclusive. Moreover, the steps of the methods 300 and 400 may be modified, adapted, rearranged, omitted, interchanged, or expanded in various ways without deviating from the scope of the present disclosure.

Furthermore, the skilled artisan will recognize the interchangeability of various features from different embodiments. Similarly, the various method steps and features described, as well as other known equivalents for each such methods and feature, may be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Turning now to FIG. 3, an embodiment of the present disclosure may include a method for operating a mixing appliance, such as the exemplary stand mixer 100 described above.

As shown in FIG. 3, the method 300 may include initiating a mixing operation of a mixing appliance, e.g., at step 310 in FIG. 3. For example, for stand mixer 100 described above, a mixing operation may be initiated, such as by a user turning on and/or selecting the mixing operation, e.g., via control panel 190. In this respect, controller 180 may operate motor 132 to rotate drive shaft 134.

Thereafter, the method 300 may include receiving data indicative of a first operational parameter associated with rotation of a drive assembly of a mixing appliance, e.g., at step 320 in FIG. 3. For example, controller 180 may be configured to receive sensor data from sensor(s) 170 indicative of the first operational parameter associated with rotation of drive assembly 130 of stand mixer 100. As described above, first operational parameter associated with rotation of drive assembly 130 may correspond to the current of motor 132, which may be indicative of the torque applied to motor 132, e.g., the torque applied to motor 132 upon contact of the bumper by the rotatable cutting tool, the rotational speed of motor 132/drive shaft 134, and/or the rotational direction of motor 132/drive shaft 134, e.g., clockwise direction, counterclockwise direction. Additionally, method 300 may include determining the first operational parameter based on the received data, e.g., at step 330 in FIG. 3. For example, in some embodiments, after receiving the data from sensor(s) 170 at step 320, controller 180 may be configured to determine the torque of motor 132. In this respect, controller 180 may access a lookup table stored within the memory device(s) of controller 180 that correlates the received sensor data, e.g., current value(s), to a torque value(s). Additionally, or alternatively, in some embodiments, controller 180 may be configured to determine the rotational speed of motor 132/drive shaft 134. In this respect, controller 180 may access a lookup table stored within the memory device(s) of controller 180 that correlates the received data to a rotational speed value(s). Additionally, or alternatively, in some embodiments controller 180 may be configured to determine the rotational direction, e.g., clockwise direction and/or counterclockwise direction, of motor 132/drive shaft 134. In this respect, controller 180 may access a lookup table stored within the memory device(s) of controller 180 that correlates the received data to a rotational direction(s).

Additionally, the method 300 may include operating the motor of the mixing appliance to adjust a second operational parameter associated with the drive assembly rotation based on the determined first operational parameter, e.g., at step 340 in FIG. 3. The second operational parameter may be a different type of operational parameter from the first operational parameter.

In some embodiments, the first operational parameter may correspond to a torque of motor 132, e.g., the torque applied to motor 132 upon contact of the bumper by the rotatable cutting tool, while the second operational parameter may correspond to the rotational direction of motor 132/drive shaft 134. As such, controller 180 may be configured to operate motor 132 of stand mixer 100 to change the rotational direction of motor 132/drive shaft 134 based on the determined torque applied to motor 132 upon contact of the bumper by the rotatable cutting tool. For example, controller 180 may compare the determined torque applied to motor 132 to a torque threshold. The torque threshold may correspond to a predetermined torque threshold stored within the memory device(s) of controller 180 and/or may be an input, e.g., via control panel 190, by the user of stand mixer 100. Thereafter, controller 180 may change the rotational direction, e.g., from clockwise rotation to counterclockwise rotation, in response to the determined torque applied to motor 132 equaling or exceeding the torque threshold.

Additionally, or alternatively, in some embodiments, the first operational parameter may correspond to a torque of motor 132, e.g., the torque applied to motor 132 upon contact of the bumper by the rotatable cutting tool, while the second operational parameter may correspond to the rotational speed of motor 132/drive shaft 134. As such, controller 180 may be configured to operate motor 132 of stand mixer 100 to change the rotational speed of motor 132/drive shaft 134 based on the determined torque applied to motor 132 upon contact of the bumper by the rotatable cutting tool. For example, controller 180 may compare the determined torque applied to motor 132 to a torque threshold. The torque threshold may correspond to a predetermined torque threshold stored within the memory device(s) of controller 180 and/or may be an input, e.g., via control panel 190, by the user of stand mixer 100. Thereafter, controller 180 may slow the rotational speed or stop rotation of motor 132/134 altogether in response to the determined torque applied to motor 132 equaling or exceeding the torque threshold.

Additionally, or alternatively, in some embodiments, the first operational parameter may correspond to a rotational speed of motor 132/drive shaft 134 while the second operational parameter may correspond to the rotational direction of motor 132/drive shaft 134. As such, controller 180 may be configured to operate motor 132 of stand mixer 100 to change the rotational direction of motor 132/drive shaft 134 based on the determined rotational speed of motor 132/drive shaft 134. For example, controller 180 may compare the determined rotational speed of motor 132/drive shaft 134 to a rotational speed threshold. The rotational speed threshold may correspond to a predetermined rotational speed threshold stored within the memory device(s) of controller 180 and/or may be an input, e.g., via control panel 190, by the user of stand mixer 100. Thereafter, controller 180 may change the rotational direction, e.g., from clockwise rotation to counterclockwise rotation, in response to the determined rotational speed of motor 132/drive shaft 134 falling below the rotational speed threshold. A slowdown in the rotational speed of motor 132/drive shaft 134 may be indicative of contact of the bumper by the rotatable cutting tool.

Additionally, or alternatively, in some embodiments, the first operational parameter may correspond to a rotational direction of motor 132/drive shaft 134 while the second operational parameter may correspond to the rotational speed of motor 132/drive shaft 134. As such, controller 180 may be configured to operate motor 132 of stand mixer 100 to change the rotational speed of motor 132/drive shaft 134 based on the determined rotational direction of motor 132/drive shaft 134. For example, controller 180 may decrease the rotational speed in response to the motor 132/drive shaft 134 rotating in one direction and increase the rotational speed in response to the motor 132/drive shaft 134 rotating in a different direction.

Additionally, or alternatively, in some embodiments, the first operational parameter may correspond to a length of time while the second operational parameter may correspond to the rotational speed of motor 132/drive shaft 134. As such, controller 180 may be configured to operate motor 132 of stand mixer 100 to change the rotational speed of motor 132/drive shaft 134 based on the length of time. For example, after the length of time has passed, controller 180 may increase or decrease the rotational speed of the motor 132/drive shaft 134.

Additionally, or alternatively, in some embodiments, the first operational parameter may correspond to a length of time while the second operational parameter may correspond to the rotational direction of motor 132/drive shaft 134. As such, controller 180 may be configured to operate motor 132 of stand mixer 100 to change the rotational direction of motor 132/drive shaft 134 based on the length of time. For example, after the length of time has passed, controller 180 may change the rotational direction of the motor 132/drive shaft 134.

Another exemplary method of operating a mixing appliance according to one or more embodiments of the present disclosure is illustrated in FIG. 4. As shown in FIG. 4, the exemplary method 400 may include a step 410 of initiating a mixing operation of a mixing appliance, e.g., as described above with respect to step 310 of method 300.

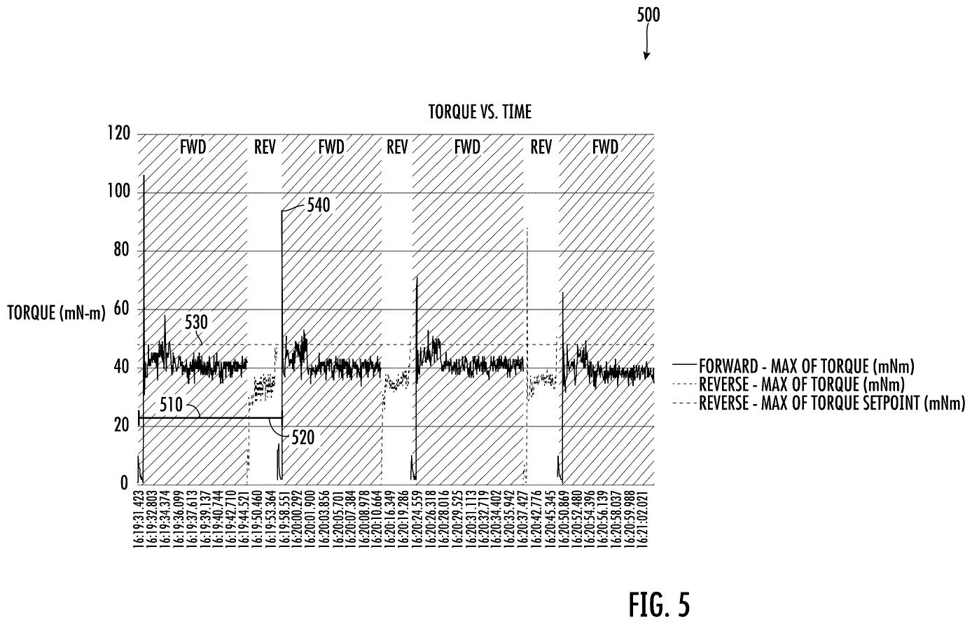

Thereafter, the method 400 may include rotating the motor in a first rotational direction for a first length of time, e.g., at step 420 in FIG. 4. For example, controller 180 may be configured to rotate motor 132/drive shaft 134 in a first rotational direction, e.g., clockwise direction, for a first length of time as indicated in a first segment 510 of torque time domain chart 500 illustrated in FIG. 5. After the first length of time has passed, the method 400 may include rotating the motor in a second rotational direction different from the first rotational direction, e.g., at step 430 in FIG. 4. For example, controller 180 may be configured to rotate motor 132/drive shaft 134 in a second rotational direction, e.g., counterclockwise direction, as indicated in a second segment 520 of torque time domain chart 500 illustrated in FIG. 5, after the first length of time has passed.

Additionally, the method 400 may include receiving data indicative of a torque of the motor, e.g., at step 440 in FIG. 4. For example, controller 180 may be configured to receive sensor data from sensor(s) 170 of the current of motor 132, which may be indicative of the torque applied to motor 132, e.g., the torque applied to motor 132 upon contact of the bumper by the rotatable cutting tool. Additionally, method 300 may include determining the torque of the motor based on the received data, e.g., at step 450 in FIG. 4. For example, in some embodiments, after receiving the data from sensor(s) 170 at step 440, controller 180 may be configured to determine the torque of motor 132/drive shaft 134. In this respect, controller 180 may access a lookup table stored within the memory device(s) of controller 180 that correlates the received data to a torque value(s).

Furthermore, the method 400 may include comparing the determined torque of the motor to a torque threshold, e.g., at step 460 in FIG. 4. For example, controller 180 may compare the determined torque of motor 132 to a torque threshold 530 as shown in FIG. 5. The torque threshold may correspond to a predetermined torque threshold stored within the memory device(s) of controller 180 and/or may be an input, e.g., via control panel 190, by the user of stand mixer 100. Thereafter, the method 400 may include rotating the motor in the first rotational direction in response to the determined torque of the motor equaling or exceeding the torque threshold, e.g., at step 470 in FIG. 4. For example, controller 180 may be configured to operate motor 132 of stand mixer 100 to rotate motor 132/drive shaft 134 in the first rotational direction in response to the determined torque of motor 132 equaling or exceeding the torque threshold as indicated by peak 540 in FIG. 5.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for operating a stand mixer, the stand mixer comprising a drive assembly including a motor and a drive shaft, the motor configured to rotate the drive shaft to drive a component of the stand mixer, the method comprising:
receiving, with a controller, data indicative of a torque of the motor;
determining, with the controller, the torque of the motor based on the received data; and
operating, with the controller, the motor to adjust an operational parameter associated with drive assembly rotation based on the determined torque of the motor, the operational parameter different from the torque of the motor.

2. The method of claim 1, wherein the operational parameter corresponds to a rotational direction of the motor.

3. The method of claim 2, wherein operating the motor comprises:
comparing, with the controller, the determined torque of the motor to a torque threshold; and
operating, with the controller, the motor to change the rotational direction of the motor in response to the determined torque of the motor equaling or exceeding the torque threshold.

4. The method of claim 1, wherein operating the motor comprises:
operating, with the controller, the motor to adjust the operational parameter associated with the drive assembly rotation based on the determined torque of the motor and a predetermined length of time.

5. The method of claim 4, wherein:
the operational parameter corresponds to a rotational direction of the motor; and
operating the motor comprises:
operating, with the controller, the motor to rotate the motor in a first rotational direction;
after the predetermined length of time has passed, operating, with the controller, the motor to rotate the motor in a second rotational direction different from the first rotational direction;
while operating the motor to rotate the motor in the second rotational direction, comparing, with the controller, the determined torque of the motor to a torque threshold; and
operating, with the controller, the motor to rotate the motor in the first rotational direction in response to the determined torque of the motor equaling or exceeding the torque threshold.

6. The method of claim 1, wherein the operational parameter corresponds to a rotational speed of the motor.

7. The method of claim 6, wherein operating the motor comprises:
comparing, with the controller, the determined torque of the motor to a torque threshold; and
operating, with the controller, the motor to change the rotational speed of the motor in response to the determined torque of the motor equaling or exceeding the torque threshold.

8. A method for operating a mixing appliance, the mixing appliance comprising a drive assembly including a motor and a drive shaft, the motor configured to rotate the drive shaft to drive a component of the mixing appliance, the method comprising:
receiving, with a controller, data indicative of a first operational parameter associated with drive assembly rotation;
determining, with the controller, the first operational parameter based on the received data; and
operating, with the controller, the motor to adjust a second operational parameter associated with the drive assembly rotation based on the determined first operational parameter, the first operational parameter different from the second operational parameter.

9. The method of claim 8, wherein the first operational parameter corresponds to one of a rotational direction of the motor or a rotational speed of the motor.

10. The method of claim 8, wherein the second operational parameter corresponds to one of a rotational direction of the motor or a rotational speed of the motor.

11. The method of claim 8, wherein:
determining the first operational parameter comprises determining a rotational speed of the motor; and
operating the motor comprises:
comparing, with the controller, the determined rotational speed of the motor to a rotational speed threshold; and
operating, with the controller, the motor to change a rotational direction of the motor in response to the determined rotational speed of the motor equaling or falling below the rotational speed threshold.

12. The method of claim 8, wherein:
determining the first operational parameter comprises determining a rotational direction of the motor; and
operating the motor comprises operating, with the controller, the motor to change a rotational speed of the motor based on the determined rotational direction.

13. A stand mixer, comprising:
a base;
a support column coupled to the base and extending upwardly from the base;
a head coupled to an upper end of the support column and extending from the support column above the base;
an attachment coupled to the head, the attachment configured to manipulate food content;
a drive assembly including a motor and a drive shaft, the motor configured to rotate the drive shaft to drive a component of the attachment;
a sensor configured to generate data indicative of a first operational parameter associated with drive assembly rotation; and
a controller operatively coupled to the sensor and the motor, the controller configured to:
operate the motor to adjust a second operational parameter associated with drive assembly rotation based on the indicated first operational parameter, the first operational parameter a different type of parameter than the second operational parameter.

14. The stand mixer of claim 13, wherein:
the second operational parameter corresponds to a rotational direction of the motor; and
operating the motor comprises operating the motor to change the rotational direction of the motor based on the indicated first operational parameter.

15. The stand mixer of claim 13, wherein:
the first operational parameter corresponds to a torque of the motor.

16. The stand mixer of claim 13, wherein:
the first operational parameter corresponds to a torque of the motor;
the second operational parameter corresponds to a rotational direction of the motor;
operating the motor comprises:
comparing the indicated torque of the motor to a torque threshold; and
operating the motor to change the rotational direction of the motor in response to the indicated torque of the motor equaling or exceeding the torque threshold.

17. The stand mixer of claim 13, wherein the attachment is configured as a pasta making attachment.

18. The stand mixer of claim 17, wherein the pasta making attachment comprises a rotatable cutting tool for cutting pasta formed by the pasta making attachment into separate pasta pieces, the rotatable cutting tool operably coupled to the drive assembly.
